(19) United States
(12) Patent Application Publication
(10) Pub. No.: US 2025/0206622 A1
(43) Pub. Date: Jun. 26, 2025

(54) ANODICALLY STABLE AND HIGHLY CONDUCTING BORANE SOLID STATE BATTERY ELECTROLYTES

(71) Applicant: Toyota Motor Engineering & Manufacturing North America, Inc., Plano, TX (US)

(72) Inventors: Rana Mohtadi, Northville, MI (US); Hiroko Kuwata, Ann Arbor, MI (US); Oscar Tutusaus, Ann Arbor, MI (US); Jian Pan, Ann Arbor, MI (US)

(73) Assignees: Toyota Motor Engineering & Manufacturing North America, Inc., Plano, TX (US); Toyota Jidosha Kabushiki Kaisha, Toyota-shi Aichi-ken (JP)

(21) Appl. No.: 18/390,446

(22) Filed: Dec. 20, 2023

(51) Int. Cl. C01B 35/12; H01M 10/0562

(52) U.S. Cl. CPC C01B 35/121; H01M 10/0562; C01P 2002/30; C01P 2002/72; C01P 2006/40; H01M 2300/008

(57) ABSTRACT

An inorganic solid state electrolyte includes a metal cation selected from Li⁺, Na⁺, Mg²⁺, Ca²⁺, Zn²⁺, or Al³⁺, and a single phase crystalline solution with a first borate cluster anion and at least one second borate cluster anion different than the first borate cluster anion. The first borate cluster anion and the at least one second borate cluster anion have the same number of vertices, but a different number of hydrogens exchanged with a halogen atom selected from F, Cl, Br, I, or a combination thereof. The inorganic solid state electrolyte also has an elastic modulus of less than 15 GPa and supports a coulombic efficiency of metal or alloy anode charging/discharging greater than 99%.

### TECHNICAL FIELD

The present disclosure generally relates to electrolytes, and particularly to electrolytes for lithium, sodium, magnesium, calcium, zinc, or aluminum batteries.

### BACKGROUND

Solid-state electrolytes provide many advantages in secondary battery design, including mechanical stability, the absence of volatility, and ease of construction. Typical inorganic solid-state electrolytes having high ionic conductivity are sulfide-based electrolytes. For example, Zhang, et al. reported that the ionic conductivity for a sulfide electrolyte can exceed 25 mS/cm, which is advantageous for battery applications (Zhang, Z., et al. “New Horizons for Inorganic Solid State Ion Conductors,” Energy Environ. Sci., 2018, 11, 1945). However, sulfide-based electrolytes suffer from the high propensity to form H₂S toxic gases upon exposure to low levels of moisture, which creates challenges for their practical use. Other classes such as polymeric and other organic have inferior ionic mobility at technologically relevant temperatures below 60° C.

The present disclosure addresses these issues with solid-state electrolytes, and other issues related to electrolytes.

### SUMMARY

In one form of the present disclosure, an inorganic solid state electrolyte includes a metal cation selected from Li⁺, Na⁺, Mg²⁺, Ca²⁺, Zn²⁺, or Al³⁺, and a single phase crystalline solution comprising a first borate cluster anion and a second borate cluster anion different than the first borate cluster anion. The first borate cluster anion and the second borate cluster anion have the same number of vertices but a different number of hydrogens exchanged with a halogen atom selected from F⁻, Cl⁻, Br⁻, I⁻, or a combination thereof. The inorganic solid state electrolyte also has an elastic modulus less than 15 GPa and a coulombic efficiency of metal plating and stripping greater than 99%.

In another form of the present disclosure, an inorganic solid state electrolyte includes a metal cation selected from Li⁺, Na⁺, Mg²⁺, Ca²⁺, Zn²⁺, or Al³⁺, and a single phase crystalline solution comprising a first borate cluster anion and one or more additional borate cluster anions that are different than the first borate cluster anion. The first borate cluster anion and the one or more additional borate cluster anions have the same number of vertices but a different number of hydrogens exchanged with a halogen atom selected from F⁻, Cl⁻, Br⁻, I⁻, or a combination thereof. The inorganic solid state electrolyte also has an elastic modulus less than 15 GPa and a coulombic efficiency of metal plating and stripping greater than 99%.

In still another form of the present disclosure, an inorganic solid state electrolyte includes a metal cation selected from Li⁺, Na⁺, Mg²⁺, Ca²⁺, Zn²⁺, or Al³⁺, and a single phase crystalline solution comprising a non-halogenated closo-borate anion and a halogenated closo-borate anion. The non-halogenated closo-borate anion and the halogenated closo-borate anion have the same number of vertices, the non-halogenated closo-borate anion has a first crystalline phase, the halogenated closo-borate anion has a second crystalline phase different than the first crystalline phase, and the single phase crystalline solution has the first crystalline phase. In addition, the inorganic solid state electrolyte also has an elastic modulus of less than 15 GPa and a coulombic efficiency of metal plating and stripping greater than 99%.

In yet another form of the present disclosure, an inorganic solid state electrolyte includes a metal cation selected from Li⁺, Na⁺, Mg²⁺, Ca²⁺, Zn²⁺, or Al³⁺, and a single phase crystalline anion solution. The single phase crystalline anion solution includes a non-halogenated closo-borate anion selected from [B_{y}H_{(y-z)}R_{z}]²⁻, [CB_{(y-1)}H_{(y-z)}R_{z}]⁻, [C₂B_{(y-2)}H_{(y-t-1)}Rₜ]⁻, [C₂B_{(y-3)}H_{(y-t)}Rₜ]⁻, or [C₂B_{(y-3)}H_{(y-t-1)}Rₜ]²⁻, and where y is an integer within a range of 6 to 12, z is an integer within a range of 0 to y, t is an integer within a range of 0 to (y-1), and R is a linear, branched-chain, or cyclic C1-C18 alkyl or partially or totally fluorinated alkyl group. The single phase crystalline anion solution also includes a halogenated closo-borate cluster anion selected from the group consisting of [B_{y}H_{(y-z-i)}R_{z}Xᵢ]²⁻, [CB_{(y-1)}H_{(y-z-i)}R_{z}Xᵢ]⁻, [C₂B_{(y-2)}H_{(y-t-j-1)}RₜXⱼ]⁻, [C₂B_{(y-3)}H_{(y-t-j)}RₜXⱼ]⁻, or [C₂B_{(y-3)}H_{(y-t-j-1)}RₜXⱼ]²⁻, and where y is an integer within a range of 6 to 12; (z+i) is an integer within a range of 0 to y, (t+j) is an integer within a range of 0 to (y-1), X is F, Cl⁻, Br⁻, I⁻, or a combination thereof, and R is a linear, branched-chain, or cyclic C1-C18 alkyl or partially or totally fluorinated alkyl group. The non-halogenated closo-borate anion and the halogenated closo-borate cluster anion have the same number of vertices and the inorganic solid state electrolyte also has an elastic modulus of less than 15 GPa and a coulombic efficiency of metal plating and stripping greater than 99%.

In still yet another form of the present disclosure, an inorganic solid state electrolyte includes a metal cation selected from Li⁺, Na⁺, Mg²⁺, Ca²⁺, Zn²⁺, or Al³⁺, and a single phase crystalline anion solution comprising at least two halogenated closo-borate anions that differ in the number and/or type of halogens present on each of these clusters. The single phase crystalline anion includes a first halogenated closo-borate cluster anion selected from the group consisting of [B_{y}H_{(y-z-i)}R_{z}Xᵢ]²⁻, [CB_{(y-1)}H_{(y-z-i)}R_{z}Xᵢ]⁻, [C₂B_{(y-2)}H_{(y-t-j-1})RₜXⱼ]⁻, [C₂B_{(y-3)}H_{(y-t-j)}RₜXⱼ]⁻, or [C₂B_{(y-3)}H_{(y-t-j-1)}RₜXⱼ]²⁻, and where y is an integer within a range of 6 to 12; (z+i) is an integer within a range of 0 to y, (t+j) is an integer within a range of 0 to (y-1), X is F, Cl⁻, Br⁻, I⁻, or a combination thereof, and R is a linear, branched-chain, or cyclic C1-C18 alkyl or partially or totally fluorinated alkyl group. A second halogenated closo-borate anion is included and comprises of [B_{y}H_{(y-z-i)}R_{z}Xᵢ]²⁻, [CB_{(y-1)}H_{(y-z-i)}R_{z}Xᵢ]⁻, [C₂B_{(y-2)}H_{(y-t-j-1)}RₜXⱼ]⁻, [C₂B_{(y-3)}H_{(y-t-j)}RₜXⱼ]⁻, or [C₂B_{(y-3)}H_{(y-t-j-1)}RₜXⱼ]²⁻, and where y is an integer within a range of 6 to 12; (z+i) is an integer within a range of 0 to y, (t+j) is an integer within a range of 0 to (y-1), X is F, Cl⁻, Br⁻, I⁻, or a combination thereof, and R is a linear, branched-chain, or cyclic C1-C18 alkyl or partially or totally fluorinated alkyl group. The two different halogenated closo-borate cluster anions have the same number of vertices but differ in the number or type of halogens present on each for these anions. For example, the second anion may have 1, 2, 3, 4, 5 or 6 more halogens present on its vertices than the first anion and the inorganic solid state electrolyte also has an elastic modulus of less than 10 GPa and a coulombic efficiency of metal plating and stripping greater than 99%.

In one form of the present disclosure, an inorganic solid state electrolyte includes a metal cation selected from Li⁺, Na⁺, Mg²⁺, Ca²⁺, Zn²⁺, or Al³⁺, and a single phase crystalline anion solution comprising two or more halogenated closo-borate anions that differ in the number of halogens present on each of these clusters. The single phase crystalline anion includes a first halogenated closo-borate cluster anion selected from the group consisting of [B_{y}H_{(y-z-i)}R_{z}Xᵢ]²⁻, [CB_{(y-1)}H_{(y-z-i)}R_{z}Xᵢ]⁻, [C₂B_{(y-2)}H_{(y-t-j-1)}RₜXⱼ]⁻, [C₂B_{(y-3)}H_{(y-t-j)}RₜXⱼ]⁻, or [C₂B_{(y-3)}H_{(y-t-j-1)}RₜXⱼ]²⁻, and where y is an integer within a range of 6 to 12; (z+i) is an integer within a range of 0 to y, (t+j) is an integer within a range of 0 to (y-1), X is F, Cl⁻, Br⁻, I⁻, or a combination thereof, and R is a linear, branched-chain, or cyclic C1-C18 alkyl or partially or totally fluorinated alkyl group. A second halogenated closo-borate anion comprises of [B_{y}H_{(y-z-i)}R_{z}Xᵢ]²⁻, [CB_{(y-1)}H_{(y-z-i)}R_{z}Xᵢ]⁻, [C₂B_{(y-2)}H_{(y-t-j-1)}RₜXⱼ]⁻, [C₂B_{(y-3)}H_{(y-t-j)}RₜXⱼ]⁻, or [C₂B_{(y-3)}H_{(y-t-j-1)}RₜXⱼ]²⁻, and where y is an integer within a range of 6 to 12; (z+i) is an integer within a range of 0 to y, (t+j) is an integer within a range of 0 to (y-1), X is F, Cl⁻, Br⁻, I⁻, or a combination thereof, and R is a linear, branched-chain, or cyclic C1-C18 alkyl or partially or totally fluorinated alkyl group. In some variations a third halogenated closo-borate anion is included and comprises of [B_{y}H_{(y-z-i)}R_{z}Xᵢ]²⁻, [CB_{(y-1)}H_{(y-z-i)}R_{z}Xᵢ]⁻, [C₂B_{(y-2)}H_{(y-t-j-1)}RₜXⱼ], [C₂B_{(y-3)}H_{(y-t-j)}RₜXⱼ]⁻, or [C₂B_{(y-3)}H_{(y-t-j-1)}RₜXⱼ]²⁻, and where y is an integer within a range of 6 to 12; (z+i) is an integer within a range of 0 to y, (t+j) is an integer within a range of 0 to (y-1), X is F, Cl⁻, Br⁻, I⁻, or a combination thereof. The halogenated closo-borate cluster anions have the same number of vertices but differ in the number and/or type of halogens present on each for these anions and/or the number and/or type of substituents (e.g., R substituents where R is a linear, branched-chain, or cyclic C1-C18 alkyl or partially or totally fluorinated alkyl group) present on each of the anions. For example, the second anion may have 1, 2, 3, 4, 5 or 6 more halogens present on its vertices than the first anion. The third anion may have 1, 2, 3, 4, 5 or 6 more halogens present on its vertices than the second anion. A fourth closo-borate anion can also be present, which differs from the first, second, and third anions in the number or type of halogens present on its vertices. For example, the first, second, or third anions may have fluorine halogen, while the fourth anion may have only chloride halogen. The inorganic solid state electrolyte also has an elastic modulus of less than 10 GPa and a coulombic efficiency of metal plating and stripping greater than 99%.

In another form of the present disclosure, an electrochemical cell includes an anode selected from the group consisting of an intercalation anode (e.g., a graphite anode), a metal anode (e.g., a Cu, Li, Mg, Ca, Na, Al, or Zn anode), an alloy anode (e.g., a Si containing anode), and an organic anode, a cathode selected from the group consisting of an insertion cathode (e.g., an oxide cathode) and a conversion cathode (e.g., a sulfur or an organic cathode), and an inorganic solid state electrolyte. The inorganic solid state electrolyte includes a metal cation selected from the group consisting of Li⁺, Na⁺, Mg²⁺, Ca²⁺, Zn²⁺, and Al³⁺, and a single phase crystalline solution with a first borate cluster anion and at least one second borate cluster anion different than the first borate cluster anion. As used herein, the phrase “at least one second borate cluster anion” refers to a second borate cluster anion and an optional third borate cluster anion, an optional fourth borate cluster anion, etc. The first borate cluster anion and the at least one second borate cluster anion have the same number of vertices and a different number of hydrogens exchanged with a halogen atom selected from the group consisting of F, Cl⁻, Br⁻, and I. The inorganic solid state electrolyte also has an elastic modulus of less than 15 GPa.

These and other features of the composite salt mixture and its preparation will become apparent from the following detailed description when read in conjunction with the figures and examples, which are exemplary, not limiting.

### BRIEF DESCRIPTION OF THE DRAWINGS

The present teachings will become more fully understood from the detailed description and the accompanying drawings, wherein:

FIG. 1A is a graphical plot of intensity as a function of angle 2θ for an x-ray diffraction scan for LiCB₁₁H₁₂ and solid state crystalline solutions of 60 mol % LiCB₁₁H₁₂ 40 mol % LiCB₁₁H₁₁F, 40 mol % LiCB₁₁H₁₂-60 mol % LiCB₁₁H₁₁F, and 30 mol % LiCB₁₁H₁₂-70 mol % LiCB₁₁H₁₁F;

FIG. 1B is a representative graphical plot showing the phase fitting of the x-day diffraction data, shown for the 40 mol % LiCB₁₁H₁₂-60 mol % LiCB₁₁H₁₁F solution, using the Rietveld Refinement method;

FIG. 2 is a graphical plot of cell volume for LiCB₁₁H₁₁F and solid state crystalline solutions of 60 mol % LiCB₁₁H₁₂-40 mol % LiCB₁₁H₁₁F, 50 mol % LiCB₁₁H₁₂-50 mol % LiCB₁₁H₁₁F, 40 mol % LiCB₁₁H₁₂-60 mol % LiCB₁₁H₁₁F, and 30 mol % LiCB₁₁H₁₂-70 mol % LiCB₁₁H₁₁F;

FIG. 3 is a graphical plot of electric potential as a function of time for a solid state crystalline solution of 40 mol % LiCB₁₁H₁₂-60 mol % LiCB₁₁H₁₁F in an asymmetric Cu/Li half cell in order to measure coulombic efficiency;

FIG. 4 is a graphical plot of coulombic efficiency as a function of cycle number for a solid state crystalline solution of 40 mol % LiCB₁₁H₁₂-60 mol % LiCB₁₁H₁₁F in an asymmetric Cu/Li half cell;

FIG. 5 is a graphical plot of electric potential as a function of time for a solid state crystalline solution of 40 mol % LiCB₁₁H₁₂-60 mol % LiCB₁₁H₁₁F in a symmetric Li/Li symmetric cell cycled every 4 hours (i.e., 1 cycle equals 2 hours of plating followed by 2 hours of stripping);

FIG. 6A is a graphical plot of electric potential as a function of capacity for a 4 V full cell battery with a Li metal anode, a lithium nickel cobalt aluminum oxide (NCA) cathode (non-coated), and a solid state crystalline solution of 40 mol % LiCB₁₁H₁₂-60 mol % LiCB₁₁H₁₁F electrolyte;

FIG. 6B is a graphical plot of coulombic efficiency of discharge vs. charge capacity, discharge capacity retention and discharge capacity as a function of cycles for a 4 V full cell battery with a Li metal anode, a lithium nickel cobalt aluminum oxide (NCA) cathode (non-coated), and a solid state crystalline solution of 40 mol % LiCB₁₁H₁₂-60 mol % LiCB₁₁H₁₁F electrolyte;

FIG. 7 is a graphical plot of the range of elastic moduli for the LiCB₁₁H₁₂-LiCB₁₁H₁₁F electrolytes according to the teachings of the present disclosure and the range of elastic moduli for traditional solid state non-polymer electrolytes; and

FIG. 8 shows an electrochemical cell with an anode, a cathode, and an electrolyte according to the teachings of the present disclosure.

It should be noted that the figures set forth herein are intended to exemplify the general characteristics of the composite salt mixtures and electrolytes of the present technology, for the purpose of the description of certain aspects. The figures may not precisely reflect the characteristics of any given aspect and are not necessarily intended to define or limit specific forms or variations within the scope of this technology.

### DETAILED DESCRIPTION

The present disclosure provides highly conductive closo-borate inorganic solid state electrolyte solutions with a unique structure and a method to prepare them. As used herein, the phrase “solid state electrolyte solution” refers to a solution of solid electrolytes with a single crystalline phase, i.e., not more than one crystalline phase, and excludes polymer and gel electrolytes. In addition, the closo-borate inorganic solid state electrolyte solutions according to the teachings of the present disclosure are also referred to herein simply as “closo-borate electrolytes.”

The closo-borate electrolytes are a single phase crystalline solution incorporating two or more borate cluster anions that have the same number of vertices but differ in the number of hydrogens that are exchanged with a halogen such as fluoride, chloride, bromide, iodine, or combinations thereof. In some variations, the halogenated closo-borate cluster anions have the same number of vertices but differ in the number or type of halogens present on each for these anions or in the number or type of substituents (e.g., R substituents where R is a linear, branched-chain, or cyclic C1-C18 alkyl or partially or totally fluorinated alkyl group) present on each for these anions. The similarities in symmetry and size between the two or more borate cluster ions allow for the formation of the single phase solid state crystalline solution.

The closo-borate electrolytes according to the teachings of the present disclosure exhibit superionic conductivity, which is due at least in part to the expansion of the crystalline lattice parameter of a poorly ion conducting closo-borate ion, while retaining the closo-borate ion's original crystal form. As used herein, the phrase “poorly ion conducting” refers to a cationic conductivity of less than 10⁻⁵ milliSiemens per centimeter (mS/cm) and the term “superionic conducting” refers to cationic conductivity greater than 10⁻⁴ mS/cm.

The closo-borate electrolytes according to the teachings of the present disclosure are soft despite being an inorganic solid state material. As used herein, the term “soft” refers to an elastic modulus of less than 15 gigapascal (GPa). It should be understood that the softness of the closo-borate electrolytes provides for or enables enhanced manufacturing of battery cells. For example, the soft closo-borate electrolytes according to the teachings of the present disclosure allow for the assembly of batteries of using simple uniaxial compression (force) at room temperature. Stated differently, batteries can be assembled without the use of elevated temperatures and/or elevated compression forces. It should also be understood that electrolytes that do require elevated temperatures, elevated compression forces, and/or shear compression forces result in the damage of the electrolytes (e.g., oxidation/degradation of the electrolyte), damage to other battery components (e.g., cracking of the anode and/or cathode), and an increase in the cost of equipment required to assemble such batteries.

The closo-borate electrolytes according to the teachings of the present disclosure, with the incorporation of one or more halogens, e.g., fluorine, results in high chemical and electrochemical compatibility with highly reactive anodes such as Li metal, Na metal, and silicon. For example, coulombic efficiency of greater than 99% is achieved for the plating and stripping of lithium (Li) metal. It should be understood that higher coulombic efficiency correlates with less loss of capacity for a battery in each charge/discharge cycle and thus a longer potential lifespan for the battery. Stated differently coulombic efficiency is the ratio (or percentage) of the total charge extracted from a battery to the total charge put into the battery over a full cycle. And due at least in part to the high compatibility of the closo-borate electrolytes with the Li metal and high voltage cathodes, solid state battery cells that operate at high voltage (4 V vs. Li) are provided without incorporating non practical measures associated with poor properties of traditional electrolytes, such as requiring coating of the active material of the electrode to prevent contact with the electrolyte or temperature treatment to process the electrolyte. Stated differently, the closo-borate solid state electrolyte solutions according to the teachings of the present disclosure have high anodic stability and compatibility with high voltage cathodes, e.g., cathodes for 4 volt (V) batteries (also known as “4V class”).

As noted above a superionic conducting closo-borate electrolyte is formed by or results from expanding the crystalline structure of a first poorly conducting closo-borate anion. In some variations, expanding the crystalline structure of the first poorly conducting closo-borate anion is achieved by incorporating one or more different closo-borate anions that have the same number of vertices but differ in the number of vertices that are hydrogen bonded with the first poorly conducting closo-borate anion. Surprisingly, this “mixture” results in the formation of a solid state electrolyte solution that combines all the anions in one crystalline structure (i.e., a single solid phase). It is postulated that the “mixture” has a single crystalline structure because the closo-borate anions have the same structural symmetry with respect to the framework of the clusters, i.e., when the differences between substituents are not taken into consideration. The solid state electrolyte solution has the same crystalline structure as the first poorly conducting closo-borate anion, but its lattice parameters are expanded such that improved or enhanced cationic diffusion occurs.

In some variations, forming or synthesizing the solid state electrolyte solution with the first poorly conducting closo-borate anion and the one or more different closo-borate anions that have the same number of vertices but differ in the number of hydrogen bonded with the first poorly conducting closo-borate anion is achieved via a mechanochemical synthesis route. Also, the solid state electrolyte solution can be heat treated at temperatures less than 250° C., which is in contrast to traditional approaches used to create superionic conducting closo-borate electrolytes that require the formation and retainment of a high temperature superionic conducting phase which is different from the room temperature phase as taught in U.S. Patent Application Publication No. 2016/0372786. That is, previous work has produced superionic conducting closo-borate electrolytes by “locking in” a high temperature superionic conducting phase at low temperatures such as 35° C. and lower. In contrast, the solid state electrolyte solutions according to the teachings of the present disclosure are superionically conductive, i.e., the superionic conducting phase is stable, at temperatures greater than 50° C., e.g., temperatures greater than 100° C., temperatures greater than 150° C., temperatures greater than 200° C., or temperatures up to but less than 250° C. To be clear, the superionic conductivity of the solid state electrolyte solutions according to the teachings of the present disclosure is due to the expansion of the crystalline cell of the first poorly conducting closo-borate anion when synthesized with the one or more different closo-borate anions that have the same number of vertices but differ in the number of substituents that are hydrogen bonded with the first poorly conducting closo-borate anion.

Without being bound to any specific theory, it is postulated that the disclosed “mixture” of anions allows for high cation mobility, e.g., Li mobility when Li⁺ is used, at temperatures near ambient temperature. This results in a low temperature superionic conducting phase without requiring the use of a metastable anionic cluster to “lock in” the increased conductivity of the high temperature phase. That is, both closo-borate anions of the disclosed “mixture” exhibit superionic conductivity at high temperature (i.e., above 150° C.). However, if used separately, the closo-borate anionic clusters of the disclosed “mixture” would exhibit low conductivity at ambient temperature. By providing a “mixture” of two distinct closo-borate anions, the resulting solid state electrolyte exhibits superionic conductivity at lower temperatures, such as temperatures of 35° C. and lower. Without being bound to any specific theory, it is postulated that the observed increased conductivity at lower temperatures results from cation interaction, e.g., Li⁺, with the substituents on the closo-borate anionic clusters. It is also observed that the “mixture” of closo-borate anionic clusters exhibits the same phase at high temperature as one of the constitute closo-borate anionic cluster ions and further demonstrates that the super cationic mobility of the solutions described herein are not due to “locking in” of any new phase appearing or observed at high temperature.

In some variations, the closo-borate anion has a structure such as [B_{y}H_{(y-z)}R_{z}]²⁻, [CB_{(y-1)}H_{(y-z)}R_{z}]⁻, [C₂B_{(y-2)}H_{(y-t-1)}Rₜ]⁻, [C₂B_{(y-3)}H_{(y-t)}Rₜ]⁻, or [C₂B_{(y-3)}H_{(y-t-1)}Rₜ]²⁻, where y is an integer within a range of 6 to 12, z is an integer within a range of 0 to y, t is an integer within a range of 0 to (y-1), and R is a linear, branched-chain, or cyclic C1-C18 alkyl or partially or totally fluorinate alkyl group. In addition, the halogenated closo-borate anion has a structure such as [B_{y}H_{(y-z-i)}R_{z}Xᵢ]²⁻, [CB_{(y-1)}H_{(y-z-i)}R_{z}Xᵢ]⁻, [C₂B_{(y-2)}H_{(y-t-j-1)}RₜXⱼ]⁻, [C₂B_{(y-3)}H_{(y-t-j)}RₜXⱼ]⁻, or [C₂B_{(y-3)}H_{(y-t-j-1)}RₜXⱼ]²⁻, where y is an integer within a range of 6 to 12; (z+i) is an integer within a range of 0 to y, (t+j) is an integer within a range of 0 to (y 1), X is F, Cl⁻, Br⁻, I⁻, or a combination thereof, and R is a linear, branched-chain, or cyclic C1-C18 alkyl or partially or totally fluorinated alkyl group.

A combination of the two or more of Li, Na, Mg, Ca, or Zn salts of halogenated closo-borate clusters with salts of non-halogenated closo-borate clusters, wherein the salts of both halogenated and non-halogenated clusters have the same number of vertices, supports the formation of superionic conducting solid state solution. In addition, combination of two or more Li, Na, Mg, Ca, or Zn salts of halogenated closo-borate anions that have different number of halogenated sites in the closo-borate anions, but have the same number of vertices, would support the formation of superionic conducting solid state solutions. In addition, a combination of two or more Li, Na, Mg, Ca, or Zn salts of halogenated closo-borate anions that have different number of R-substituted sites in the closo-borate anions, but have the same number of vertices, support the formation of superionic conducting solid state solutions. The measured elastic modulus of the solid state electrolytes is very low, ranging from 0.5-15 GPa, e.g., between 4-10 GPa.

Although ordinarily cations such as Li⁺, Na⁺, Mg²⁺, Ca²⁺, or Zn²⁺ will readily form halide salts in the presence of halogens, the disclosed “mixture” of halogenated closo-borate anionic clusters and non-halogenated closo-borate anionic clusters allows the use of these cations in the presence of halogens. Thus, it is possible to use high voltage cathodes based on Li in the presence of halogenated closo-borate anions. It is postulated that halogenated closo-borate anionic clusters have enhanced high voltage stability due to the electron withdrawing effect of the halogen substituents. As a result, the closo-borate clusters will be less prone to decomposition at higher voltages.

In some variations, a superionic conducting closo-borate electrolyte according to the teachings of the present disclosure can include one or more additional conductivity enhancing anions. A mole fraction of the one or more additional conductivity enhancing anion to the total anions in the composite salt mixture can be from about 0.01 to about 0.9. Also, the one or more additional conductivity enhancing anions can be selected from F⁻, Cl⁻, Br⁻, I⁻, RₓBF₄₋ₓ⁻, R_{y}PF_{6-y}⁻, SbF₆⁻, ClO₄⁻, SO₄²⁻, N(SO₂F)₂⁻, N(SO₂(CF₂)ₙCF₃)₂, [NSO₂(CF₂)ₙ₊₁SO₂]⁻, or CF₃(CF₂)ₙSO₃⁻, where: n is 0 to 5; x is 0 to 4; y is 0 to 6; and R is a linear, branched, or cyclic alkyl group that can be unsubstituted, partially fluorinated, or fully fluorinated.

In some variations, an electrochemical device that includes an anode, a cathode, and an electrolyte with the combined non-halogenated closo-borate/halogenated closo-borate salt in contact with the anode and the cathode is provided in the present disclosure. The electrochemical device can be a secondary battery or a subunit of a secondary battery. The anode is an electrode of alkali metal or alkali earth metal, or insertion-type or alloy-type materials where oxidation occurs during the discharge of the device and where reduction occurs during the charging of the device. Similarly, the cathode is an electrode where a cathode material reduction occurs during the discharge of the device and a cathode material oxidation occurs during the charging of the device.

In order to better illustrate the teachings of the present disclosure but without limiting the scope in any manner, discussion of synthesis and testing of superionic conducting closo-borate electrolytes is provided below.

### EXAMPLES

Closo-borate electrolytes with varying amounts of LiCB₁₁H₁₂ and LiCB₁₁H₁₁F were synthesized by mixing between 20-60 milligrams of LiCB₁₁H₁₂ with between 40-80 milligrams of LiCB₁₁H₁₁F in a mortar and grinding the mixture with a pestle for between 2-10 minutes to produce different powder mixtures (i.e., powders with different amount of the LiCB₁₁H₁₂ and the LiCB₁₁H₁₁F). Particularly, powder mixtures of (in mole percent) 60 mol % LiCB₁₁H₁₂-40 mol % LiCB₁₁H₁₁F, 50 mol % LiCB₁₁H₁₂-50 mol % LiCB₁₁H₁₁F, 40 mol % LiCB₁₁H₁₂-60 mol % LiCB₁₁H₁₁F, and 30 mol % LiCB₁₁H₁₂-70 mol % LiCB₁₁H₁₁F were prepared. In addition, powder of pure (100 wt. %) LiCB₁₁H₁₂ was prepared similarly for comparative testing.

Each of the powder mixtures was loaded into 10-50 mL zirconia jars with zirconia milling balls (2-4 big balls and 4-8 small balls with a diameter of 5 mm and 3 mm, respectively). The jars were sealed well to avoid contact with air and the mixing and loading of the jars process was performed in a glove box with the concentration of both H₂O and O₂ less than 0.1 ppm. The sealed jars were then transferred to a ball mill machine and ball milled at 400-700 rpm for 10-24 hours with 1-5 minutes rest after each hour. Then, the sealed jars were transferred back to the glove box and opened to collect the ball milled powders, which in turn were used for the testing described below.

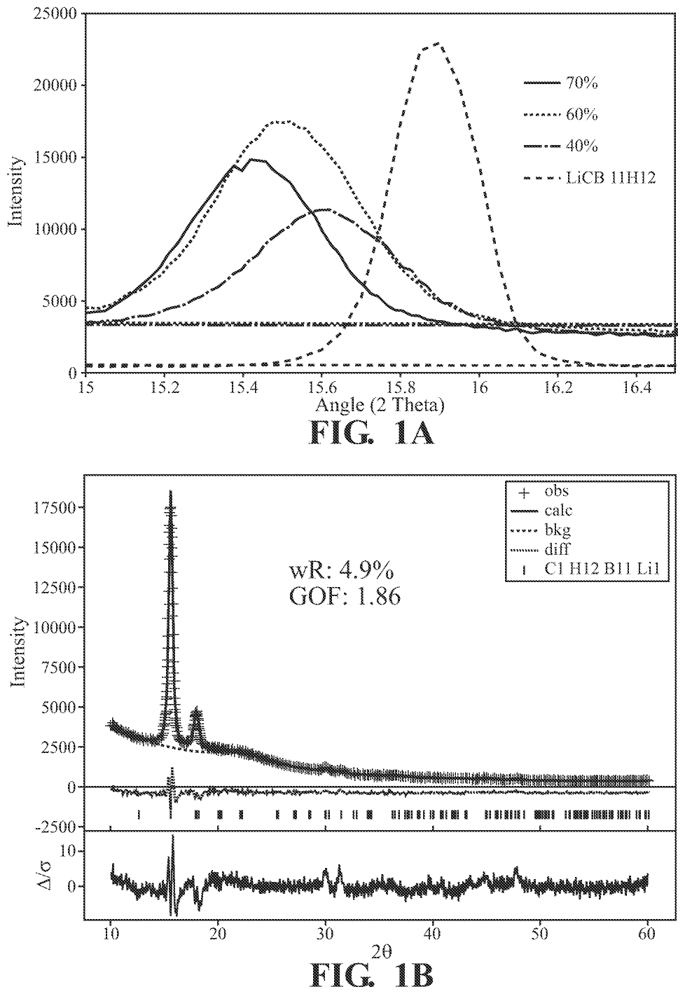

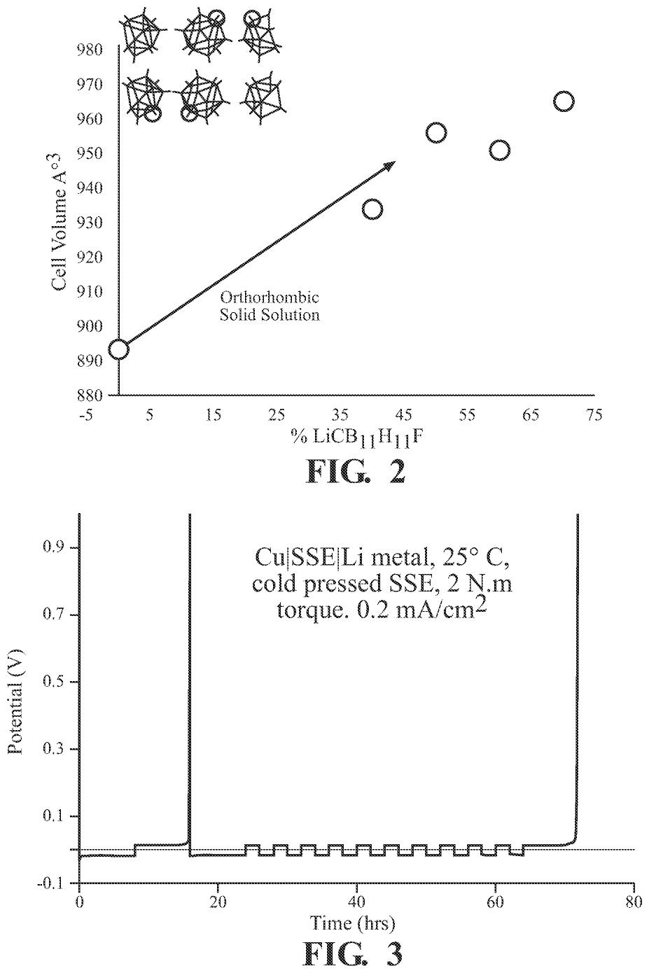

Referring to FIG. 1A, a graphical plot of intensity as a function of angle 2θ for an x-ray diffraction (XRD) scan of LiCB₁₁H₁₂ and solid state electrolyte solutions of 60 mol % LiCB₁₁H₁₂-40 mol % LiCB₁₁H₁₁F, 40 mol % LiCB₁₁H₁₂-60 mol % LiCB₁₁H₁₁F, and 30 mol % LiCB₁₁H₁₂-70 mol % LiCB₁₁H₁₁F. The crystal structure of LiCB₁₁H₁₂ is orthorhombic and the crystal structure for LiCB₁₁H₁₁F is monoclinic. However, the crystal structures for the 60 mol % LiCB₁₁H₁₂-40 mol % LiCB₁₁H₁₁F, 40 mol % LiCB₁₁H₁₂-60 mol % LiCB₁₁H₁₁F, and 30 mol % LiCB₁₁H₁₂-70 mol % LiCB₁₁H₁₁F powders, as determined by XRD analysis, were all orthorhombic. In addition, the 15.82° LiCB₁₁H₁₂ 2θ peak for pure LiCB₁₁H₁₂ shifted left (decreased) with increasing content of LiCB₁₁H₁₁F. Stated differently, the 15.82° 2θ peak for the orthorhombic crystal structure shifted to lower values as the amount of LiCB₁₁H₁₁F in the LiCB₁₁H₁₂-LiCB₁₁H₁₁F solid solution increased. And referring to FIG. 1B, a representative graphical plot showing the phase fitting of the x-day diffraction data for the 40 mol % LiCB₁₁H₁₂-60 mol % LiCB₁₁H₁₁F solution is shown using Rietveld Refinement method, demonstrating excellent structural phase fitting to an orthorhombic structure. In addition, the decrease in the 15.82° orthorhombic XRD peak to lower values corresponds to an increase in the orthorhombic crystal structure lattice parameters and a corresponding increase in the orthorhombic crystal structure cell volume as shown in FIG. 2. Not being bound by any particular theory, the increase in the orthorhombic crystal structure cell volume (size) results in an increase in cationic conductivity, i.e., superionic conductivity.

Referring to FIG. 3, a graphical plot illustrating the high compatibility of the 40 mol % LiCB₁₁H₁₂-60 mol % LiCB₁₁H₁₁F single phase solid state electrolyte with a Li anode is shown. Particularly, the 40 mol % LiCB₁₁H₁₂-60 mol % LiCB₁₁H₁₁F powder described above was used to make an asymmetric Cu/Li half cell. The asymmetric Cu/Li half cell was formed by cold pressing the 40 mol % LiCB₁₁H₁₂-60 mol % LiCB₁₁H₁₁F powder between the Cu cathode and the Li anode at 25° C. with 2 Nm torque on torque screws used for the cold pressing. The Cu/Li half cell was then subjected to a constant current density of 0.2 mA/cm² while the potential and the amount of Li metal cycled across the Cu/Li half cell were measured as shown in the figure. And as illustrated in FIG. 3, the Aurbach method was utilized to measure the coulombic efficiency. That is, after an activation cycle of 1.6 mAh/cm² and a plating step of another 1.6 mAh/cm², the cell was cycled under 0.2 mA/cm for 10 cycles, followed by a final stripping step. Based on this measurement, a high coulombic efficiency of over 99.5% was obtained which is the highest so far reported in literature for inorganic, all solid state electrolytes.

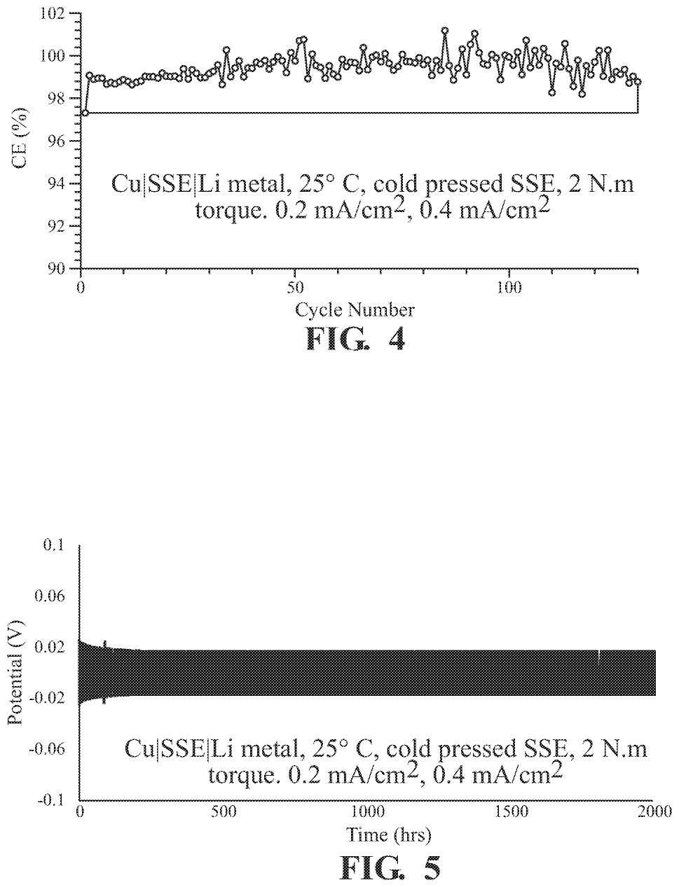

Referring to FIG. 4, a graphical plot illustrating the high cyclic stability of the 40 mol % LiCB₁₁H₁₂-60 mol % LiCB₁₁H₁₁F single phase solid state electrolyte in an asymmetric Cu/Li half cell is shown. As used herein, the phrase “cyclic stability” refers to the number of charging or discharging cycles a battery experiences until the battery capacity is reduced to a predefined amount (e.g., 50% of the initial battery capacity) and the phrase “battery capacity” refers to the total amount of electrical energy (in ampere hours) generated due to electrochemical reactions in the battery. Still referring to FIG. 4, an asymmetric Cu/Li half cell formed by cold pressing the 40 mol % LiCB₁₁H₁₂-60 mol % LiCB₁₁H₁₁F powder between a Cu cathode and a Li anode at 25° C. with 2 Nm torque was cycled stably maintaining a high coulombic efficiency exceeding 99% (averaged) to more than 100 cycles.

Referring to FIG. 5, a graphical plot illustrating the high cyclic stability of the 40 mol % LiCB₁₁H₁₂-60 mol % LiCB₁₁H₁₁F single phase solid state electrolyte in a symmetric Li/Li cell is shown. Particularly, a symmetric Li/Li cell formed by cold pressing the 40 mol % LiCB₁₁H₁₂-60 mol % LiCB₁₁H₁₁F powder between a Li cathode and a Li anode at 25° C. with 2 Nm torque was cycled stably maintaining a low overpotential of Li metal plating and stripping of less than 0.03 V vs. Li for over 2000 hours.

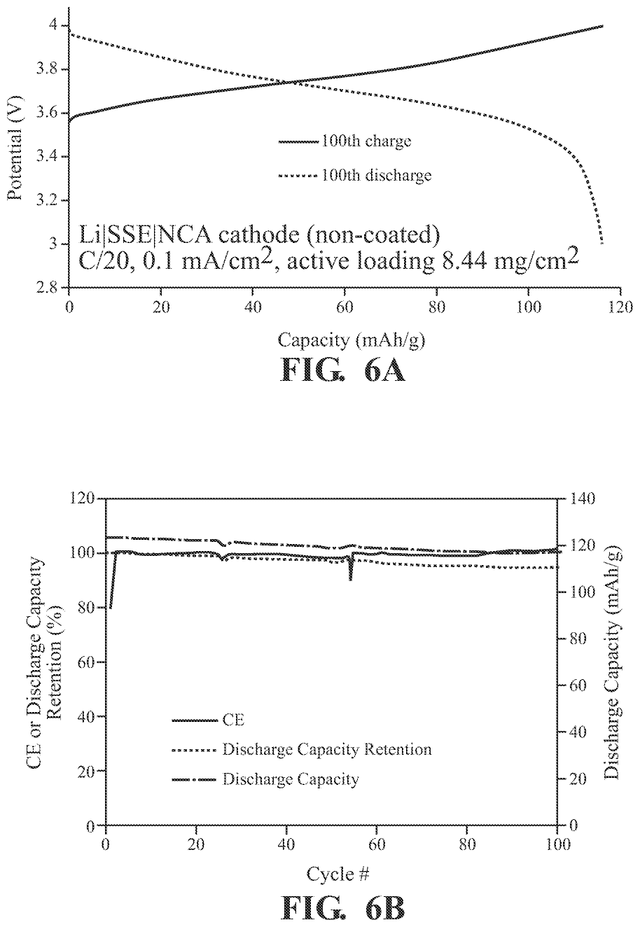

Referring to FIGS. 6A and 6B, a graphical plot illustrating high cyclic stability and coulombic efficiency for a 4 V full cell battery with a Li metal anode, a lithium nickel cobalt aluminum oxide (NCA) cathode, and a solid state crystalline solution of 40 mol % LiCB₁₁H₁₂-60 mol % LiCB₁₁H₁₁F electrolyte is shown. Particularly, FIG. 6A shows electrical potential as a function of capacity for the 100th charge and discharge of the 40 mol % LiCB₁₁H₁₂-60 mol % LiCB₁₁H₁₁F electrolyte full cell battery with C/20 current, indicating the cell is still capable of functioning at the 100th cycle. FIG. 6B shows coulombic efficiency or discharge capacity retention as a percentage and discharge capacity as a function of cycle number. The cell stably cycles maintaining a high coulombic efficiency exceeding 99% and a capacity retention of greater than 94% after 100 cycles.

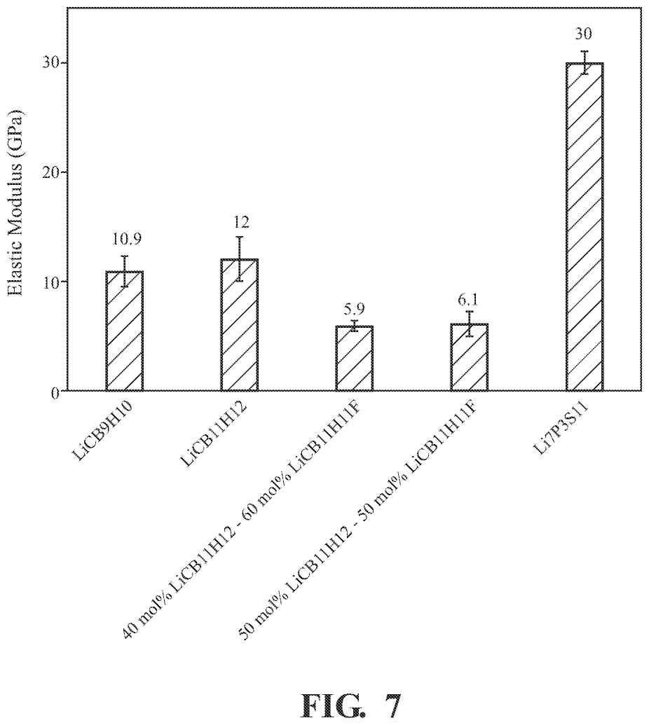

Referring to FIG. 7, a graphical plot of the range of elastic moduli for the LiCB₁₁H₁₂-LiCB₁₁H₁₁F electrolytes according to the teachings of the present disclosure and the range of elastic moduli for traditional solid state non-polymer electrolytes are shown. And as observed from FIG. 7, the LiCB₁₁H₁₂-LiCB₁₁H₁₁F electrolytes, shown for 40 mol % LiCB₁₁H₁₂-60 mol % LiCB₁₁H₁₁F and 50 mol % LiCB₁₁H₁₂-50 mol % LiCB₁₁H₁₁F according to the teachings of the present disclosure exhibit a reduced elastic modulus compared to traditional solid state non-polymer electrolytes and other example closo-borate salts, including pristine LiCB₁₁H₁₂, which in turns allows for the fabrication of battery cells at room temperature as noted above. For example, solid-state electrolytes are typically formed into a desired shape by compacting granules or powder of the solid electrolyte, such as in a dye press. In addition, harder (traditional) solid-state electrolytes require greater pressure to achieve adequate compaction and grain-to-grain contact, whereas softer solid-state electrolytes according to the teachings of the present disclosure can be adequately compacted at lower pressure.

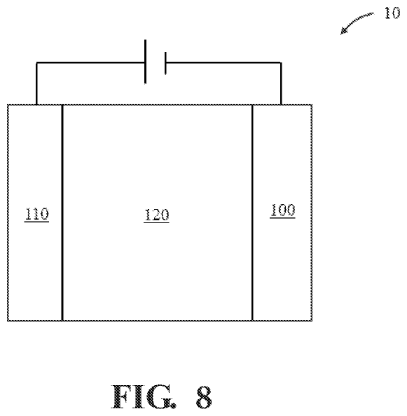

Referring to FIG. 8, an electrochemical cell 10 with an anode 100 as disclosed herein, a cathode 110 as disclosed herein, and an inorganic solid state electrolyte 120 according to the teachings of the present disclosure is shown.

The preceding description is merely illustrative in nature and is in no way intended to limit the disclosure, its application, or uses. As used herein, the phrase at least one of A, B, and C should be construed to mean a logical (A or B or C), using a non-exclusive logical “or.” It should be understood that the various steps within a method may be executed in different order without altering the principles of the present disclosure. Disclosure of ranges includes disclosure of all ranges and subdivided ranges within the entire range.

The headings (such as “Background” and “Summary”) and sub-headings used herein are intended only for general organization of topics within the present disclosure and are not intended to limit the disclosure of the technology or any aspect thereof. The recitation of multiple forms or variations having stated features is not intended to exclude other forms or variations having additional features, or other forms or variations incorporating different combinations of the stated features.

As used herein the term “about” when related to numerical values herein refers to known commercial and/or experimental measurement variations or tolerances for the referenced quantity. In some variations, such known commercial and/or experimental measurement tolerances are +/−10% of the measured value, while in other variations such known commercial and/or experimental measurement tolerances are +/−5% of the measured value, while in still other variations such known commercial and/or experimental measurement tolerances are +/−2.5% of the measured value. And in at least one variation, such known commercial and/or experimental measurement tolerances are +/−1% of the measured value.

As used herein, the terms “comprise” and “include” and their variants are intended to be non-limiting, such that recitation of items in succession or a list is not to the exclusion of other like items that may also be useful in the devices and methods of this technology. Similarly, the terms “can” and “may” and their variants are intended to be non-limiting, such that recitation that a form or variation can or may comprise certain elements or features does not exclude other forms or variations of the present technology that do not contain those elements or features.

The broad teachings of the present disclosure can be implemented in a variety of forms. Therefore, while this disclosure includes particular examples, the true scope of the disclosure should not be so limited since other modifications will become apparent to the skilled practitioner upon a study of the specification and the following claims. Reference herein to one aspect, or various aspects means that a particular feature, structure, or characteristic described in connection with a form or variation is included in at least one form or variation. The appearances of the phrase “in one variation” or “in one form” (or variations thereof) are not necessarily referring to the same form or variation. It should be also understood that the various method steps discussed herein do not have to be carried out in the same order as depicted, and not each method step is required in each form or variation.

The foregoing description of the forms or variations has been provided for purposes of illustration and description. It is not intended to be exhaustive or to limit the disclosure. Individual elements or features of a particular form or variation are generally not limited to that particular form or variation, but, where applicable, are interchangeable and can be used in a selected form or variation, even if not specifically shown or described. The same may also be varied in many ways. Such variations should not be regarded as a departure from the disclosure, and all such modifications are intended to be included within the scope of the disclosure.

While particular forms or variations have been described, alternatives, modifications, variations, improvements, and substantial equivalents that are or may be presently unforeseen may arise to applicants or others skilled in the art. Accordingly, the appended claims as filed and as they may be amended, are intended to embrace all such alternatives, modifications variations, improvements, and substantial equivalents.

What is claimed is:

1. An inorganic solid state electrolyte comprising:
a metal cation selected from the group consisting of Li⁺, Na⁺, Mg²⁺, Ca²⁺, Zn²⁺, and Al³⁺;
a single phase crystalline solution comprising a first borate cluster anion and at least one second borate cluster anion different than the first borate cluster anion, the first borate cluster anion and the at least one second borate cluster anion having the same number of vertices and a different number of hydrogens exchanged with a halogen atom selected from the group consisting of F, Cl, Br, I, or combinations thereof, or a different number or type of substituents present on each for the first borate cluster anion and the at least one second borate cluster anion; and
an elastic modulus of less than 15 GPa.

2. The inorganic solid state electrolyte according to claim 1, wherein the first borate cluster anion and the at least one second borate cluster ion are selected from the group consisting of [B_{y}H_{(y-z-i)}R_{z}Xᵢ]²⁻, [CB_{(y-1)}H_{(y-z-i)}R_{z}Xᵢ]⁻, [C₂B_{(y-2)}H_{(y-t-j-1)}RₜXⱼ], [C₂B_{(y-3)}H_{(y-t-j)}RₜXⱼ]⁻, or [C₂B_{(y-3)}H_{(y-t-j-1)}RₜXⱼ]²⁻, where y is an integer within a range of 6 to 12; (z+i) is an integer within a range of 0 to y, (t+j) is an integer within a range of 0 to (y-1), X is F, Cl⁻, Br⁻, I⁻, or a combination thereof, and R is a linear, branched-chain, or cyclic C1-C18 alkyl or partially or totally fluorinated alkyl group.

3. The inorganic solid state electrolyte according to claim 2, wherein the first borate cluster anion is a halogenated closo-borate anion and the at least one second borate cluster anion is a halogenated closo-borate anion.

4. The inorganic solid state electrolyte according to claim 2, wherein the first borate cluster anion is a non-halogenated closo-borate anion and the at least one second borate cluster anion is a halogenated closo-borate anion.

5. The inorganic solid state electrolyte according to claim 4, wherein the first borate cluster anion has a first crystalline phase, the at least one second borate cluster anion has a second crystalline phase different than the first crystalline phase, and the single phase crystalline solution has the first crystalline phase.

6. The inorganic solid state electrolyte according to claim 5, wherein the first borate cluster anion is a CB₁₁H₁₂⁻ and the second borate cluster anion is CB₁₁H₁₁X⁻, where X⁻ is F⁻, Cl⁻, Br⁻, or I⁻.

7. The inorganic solid state electrolyte according to claim 6, wherein a concentration, in mole percent, of the second borate cluster anion in the single phase crystalline solution is between about 1 mol % and about 90 mol %.

8. The inorganic solid state electrolyte according to claim 6, wherein the metal cation is Li⁺, Na⁺, or a combination thereof.

9. The inorganic solid state electrolyte according to claim 6, wherein a cell volume of the single phase crystalline solution increases with increasing content of the second borate cluster anion.

10. The inorganic solid state electrolyte according to claim 6, wherein the elastic modulus is between about 4 GPa and about 8 GPa.

11. The inorganic solid state electrolyte according to claim 1 further comprising one or more additional conductivity enhancing anions, wherein a mole fraction of the one or more additional conductivity enhancing anions to the total anions in the single phase crystalline solution is between about 0.01 to about 0.9, and the one or more additional conductivity enhancing anions is selected from F⁻, Cl⁻, Br⁻, I⁻, RₓBF₄₋ₓ⁻, R_{y}PF_{6-y}⁻, SbF₆⁻, ClO₄⁻, SO₄², N(SO₂F)₂⁻, N(SO₂(CF₂)ₙCF₃)₂⁻, [NSO₂(CF₂)ₙ₊₁SO₂]⁻, or CF₃(CF₂)ₙSO₃⁻, where: n is 0 to 5; x is 0 to 4; y is 0 to 6; and R is a linear, branched, or cyclic alkyl group that can be unsubstituted, partially fluorinated, or fully fluorinated.

12. An inorganic solid state electrolyte comprising:
a metal cation selected from the group consisting of Li⁺, Na⁺, Mg²⁺, Ca²⁺, Zn²⁺, and Al³⁺; and
a single phase crystalline solution comprising a non-halogenated closo-borate anion and a halogenated closo-borate cluster anion, the non-halogenated closo-borate anion and the halogenated closo-borate cluster anion having the same number of vertices;
an elastic modulus of between about 1 GPa and about 10 GPa; and
a coulombic efficiency of metal or silicon anode discharge/charge greater than 99%,
wherein the non-halogenated closo-borate anion has a first crystalline phase, the halogenated closo-borate anion has a second crystalline phase different than the first crystalline phase, and the single phase crystalline solution has the first crystalline phase.

13. The inorganic solid state electrolyte according to claim 12, wherein the non-halogenated closo-borate anion is selected from the group consisting of [B_{y}H_{(y-z)}R_{z}]²⁻, [CB_{(y-1)}H_{(y-z)}R_{z}]⁻, [C₂B_{(y-2)}H_{(y-t-1)}Rₜ]⁻, [C₂B_{(y-3)}H_{(y-t)}Rₜ]⁻, or [C₂B_{(y-3)}H_{(y-t-1)}Rₜ]²⁻, and where y is an integer within a range of 6 to 12, z is an integer within a range of 0 to y, t is an integer within a range of 0 to (y-1), and R is a linear, branched-chain, or cyclic C1-C18 alkyl or partially or totally fluorinated alkyl group.

14. The inorganic solid state electrolyte according to claim 13, wherein the halogenated closo-borate anion is selected from the group consisting of [B_{y}H_{(y-z-i)}R₂Xᵢ]²⁻, [CB_{(y-1)}H_{(y-z-i)}R_{z}Xᵢ]⁻, [C₂B_{(y-2)}H_{(y-t-j-1)}RₜXⱼ]⁻, [C₂B_{(y-3)}H_{(y-t-j)}RₜXⱼ]⁻, or [C₂B_{(y-3)}H_{(y-t-j-1)}RₜXⱼ]²⁻, where y is an integer within a range of 6 to 12; (z+i) is an integer within a range of 0 to y, (t+j) is an integer within a range of 0 to (y-1), X is F, Cl, Br, I, or a combination thereof, and R is a linear, branched-chain, or cyclic C1-C18 alkyl or partially or totally fluorinated alkyl group.

15. The inorganic solid state electrolyte according to claim 14, wherein the non-halogenated closo-borate anion is CB₁₁H₁₂⁻ and the halogenated closo-borate anion is CB₁₁H₁₁X⁻.

16. The inorganic solid state electrolyte according to claim 15, wherein a concentration, in mole percent, of the halogenated closo-borate anion in the single phase crystalline solution is between about 1 mol % and about 90 mol %.

17. The inorganic solid state electrolyte according to claim 15, wherein the metal cation is Li⁺, Na⁺, or a combination thereof.

18. The inorganic solid state electrolyte according to claim 15, wherein a cell volume of the single phase crystalline solution increases with increasing content of the halogenated closo-borate cluster anion.

19. An electrochemical cell comprising:
an anode selected from the group consisting of an intercalation anode, a metal anode, an alloy anode, and an organic anode;
a cathode selected from the group consisting of an insertion cathode, a conversion cathode, and an organic cathode; and
an inorganic solid state electrolyte comprising:
metal cation selected from the group consisting of Li⁺, Na⁺, Mg²⁺, Ca²⁺, Zn²⁺, and Al³⁺;
a single phase crystalline solution comprising a first borate cluster anion and at least one second borate cluster anion different than the first borate cluster anion, the first borate cluster anion and the at least one second borate cluster anion having the same number of vertices and a different number of hydrogens exchanged with a halogen atom selected from the group consisting of F, Cl, Br, I, or combinations thereof, or a different number or type of substituents present on each for the first borate cluster anion and the at least one second borate cluster anion; and
an elastic modulus of less than 15 GPa.

20. The inorganic solid state electrolyte according to claim 19, wherein a cell volume of the single phase crystalline solution increases with increasing content of the at least one second borate cluster anion.
